(19) United States
(12) Patent Application Publication
(10) Pub. No.: US 2017/0013850 A1
(43) Pub. Date: Jan. 19, 2017

(54) A SOLUTION FOR EXTENDING SHELF LIFE OF READY-TO-EAT FRESH FRUITS AND/OR VEGETABLES AND AN APPLICATION METHOD THEREOF

(71) Applicant: VURAL GOKMEN, Ankara (TR)

(72) Inventors: VURAL GOKMEN, Ankara (TR); KUBRA SULTAN OZDEMIR, Ankara (TR)

(21) Appl. No.: 15/124,277

(22) PCT Filed: Mar. 17, 2015
(86) PCT No.: PCT/TR2015/000112

§ 371 Date: Sep. 7, 2016

(30) Foreign Application Priority Data
Mar. 18, 2014 (TR) 2014/03124

(51) Int. Cl. A23B 7/154; A23B 7/10; A23B 7/16

(52) U.S. Cl. CPC A23B 7/154; A23B 7/16; A23B 7/10; A23V 2002/00

(57) ABSTRACT

The present invention relates to a solution and an application method thereof for extending shelf life of ready-to-eat fresh fruits and/or vegetables, and characterized by comprising chitosan and ascorbic acid.

### TECHNICAL FIELD

The present invention relates to a solution and an application method thereof for extending shelf life of ready-to-eat fresh fruits and/or vegetables.

### BACKGROUND OF THE INVENTION

It is of vital importance for food sector that shelf life of fresh fruits and/or vegetables presented as ready-to-eat. When the said products are presented to end consumers particularly as sliced or peeled, negative conditions may occur such as fleshy parts of fruits or vegetables change colour, taste and structure of products change. Besides, because of antimicrobial substances used for extending shelf life it cannot be possible to consume these products without being cleared of these substances.

Although there are various techniques known in the art in order to extend shelf life, the said applications have not been able to provide an effective solution for the existing problem due to the fact that they cause natural colours of products to deteriorate or cannot maintain taste of the product.

One of the techniques commonly used for extending shelf life is applying chitosan (a linear aminopolysaccaride obtained by deacetylation of chitin, which is a polysaccaride) onto fruits or vegetables. The Chinese patent document no. CN101669541, wherein the said embodiment is disclosed, mentions that a ternary mixture comprising ascorbic acid, chitosan and a fungicide is used with the purpose of extending shelf life of leechee (Litchi) fruit post-harvest. Thus, mould formation can be avoided in a product by means of fungicide and storage life of leechee fruit can be extended. However, due to the fact that fungicide forms a film layer on the said fruit and thus the said fruit cannot be presented to consumers in a ready-to-eat status, no solution can be provided for the existing problem mentioned in the said document.

Besides chitosan application, there are other studies in order to extend shelf life in the art. For example, the European patent document no. EE2279675 discloses that shelf life is extended by applying a mixture of water, calcium and ascorbate ions onto ready-to-eat fruits. In the method disclosed in the said document, a sodium hypochlorite solution is used for the purpose of reducing microbial load of fruits before application of a mixture of calcium and ascorbate is carried out. Then the mixture of calcium and ascorbate prepared is applied onto the fresh-cut fruit. However, due to the fact that the sodium hypochlorite disclosed, in the said document is a toxic substance they are inappropriate to be used on ready-to-eat products.

The international patent document no. WO2010010059 discloses extending shelf life of ready-to-eat fruits and vegetables via the combined use of acidification and ultraviolet light application.

The International patent document no. WO2003005830 discloses extending shelf life of ready-to-eat fresh-cut salads and fruits by using nitric oxide in a modified atmosphere packaging technique. However, hazardous effects on human health may occur in this method as well due to the fact that nitric oxide is a toxic substance as is the case with the European patent document no. EP2279675.

### SUMMARY OF THE INVENTION

An objective of the present invention is to realize a solution and an application method of the said solution which are used for extending shelf life of ready-to-eat fruits and/or vegetables by application of chitosan and ascorbic acid without any chemical and/or physical change (taste, colour, smell, etc. of fruits and/or vegetables are maintained).

Another objective of the present invention is to realize a solution and an application method of the said solution which avoid development of microorganisms on fruits and/or vegetables, enables to maintain colours of fruits and/or vegetables and keep taste of fruits and/or vegetables.

A further objective of the present invention is to realize a solution and an application method of the said solution which enables to consume fruits and/or vegetables without needing a cleansing process afterwards.

### DETAILED DESCRIPTION OF THE INVENTION

“A Solution for Extending Shelf Life of Ready-To-Eat Fresh Fruits and/or Vegetables and an Application Method Thereof” realized to fulfill the objectives of the present invention is shown in the figure attached, in which:

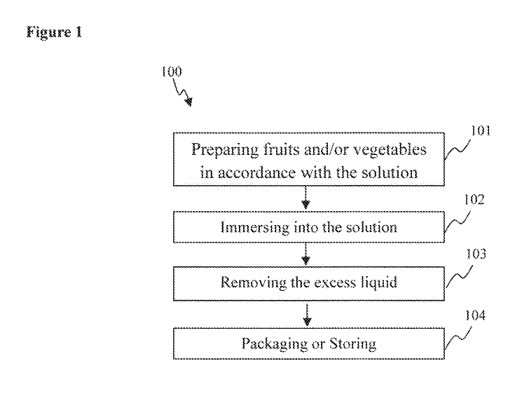

FIG. 1 is a flow chart of the inventive method.

The components illustrated in the figure are individually numbered, where the numbers refer to the following:

100. Method

The solution used for extending shelf life of ready-to-eat fruits and/or vegetables comprise chitosan and ascorbic acid within the aqueous solution. Due to the fact that the chitosan in the content of the solution is an antibacterial substance, microbial activity is restricted on a fruit and/or vegetable. In addition, fruit and/or vegetable healthy to be consumed are also obtained because it is antioxidant and anticarcinogenic. Ascorbic acid, which is another substance included in the solution content, enables chitosan to dissolve inside the solution by increasing acidity of the solution and at the same time, it also prevents browning occurring due to enzymatic oxidation of phenolic substances included in the structure of cut fruits and/or vegetables. Thus, it is ensured that colour, taste and nutritional elements of a fruit and/or vegetable are maintained for a long period of time. In a preferred embodiment of the invention, there are one per cent chitosan and one to five per cent ascorbic acid in the aqueous solution.

Amount of chitosan within the aqueous solution is preferably 10 g per litre whereas amount of ascorbic acid varies between 10 to 50 g per litre according to the fruit and/or vegetable where application will be carried out.

For example, colour and anthocyanin profile are maintained for 3 weeks at 4° C. When deseeded pomegranates are immersed into a solution comprising 10 g chitosan and 10 g ascorbic acid per litre. 4 anthocyanin substances—namely cyanidine 3-glycoside, cyanidine 3-5 diglucoside, pelargonidin 3-glycoside and pelargonidin 3,5 diglucoside—were determined in pomegranate seeds. Total amount of anthocyanin in pomegranate seeds, which were coated by the chitosan-ascorbic acid solution was determined as 1466 mg/kg and no significant change was detected in the total amount of anthocyanin substances at the end of storing (p<0.05).

In spite of that, a solution comprising 10 g chitosan and 50 g ascorbic acid per litre are used so as to maintain colour and phenolic compound profile of fresh-cut apples for 2 weeks at 4° C.

In a preferred embodiment of the invention, for example a solution which is prepared for deseeded pomegranates or sliced apples comprises chitosan in the ratio of 1% and ascorbic acid in the ratio of 1%.

In another embodiment, for example a solution which is prepared for fresh-cut apples comprises 1% chitosan and 5% ascorbic acid.

The method (100) which is developed for applying the said solution comprises steps of:
preparing the fruits and/or vegetables where the solution will be applied, for solution application (101);
immersing the fruits and/or vegetables into the chitosan and ascorbic acid solution which is prepared in accordance with their characteristics (102) for a definite period;
after the immersing process (102) removing the liquid which remains on the fruits and/or vegetables (103); and
packaging or storing the fruits and/or vegetables wherein the liquid remaining on thereof is removed (104).

In the application method (100) developed by the present invention, at the step of preparing the fruits and/or vegetables for solution application (101): the said products are—for example—washed, shelled, peeled, cut or deseeded, Thus, the solution is enabled to have an effect upon the product more effectively by increasing the surface area of the said products. After the preparing (101) process, the product is immersed into the solution prepared in accordance with the characteristic thereof (102). By means of the removing the liquid, which remains on the products, hold in a certain amount of solution (103), the products become appropriate fir packaging or storing (104) and thus ready-to-eat products having no remaining liquid on thereof can be obtained.

In an exemplary embodiment indicating the application method of the invention, deseeded pomegranate was kept in a solution comprising 1% chitosan and 1% ascorbic, acid for 10 minutes. The seeds coated by the solution were left to storing at 5° C. after they were put into polyethylene containers of 50 mL. In this example, no microbiological risk formation was detected for 3 weeks after the analysis carried out on the pomegranate and there was no change of smell, colour or taste in the pomegranate. In the pomegranate seeds wherein chitosan-ascorbic acid solution was applied at the end of 3 weeks in terms of total number of yeast and mould, approximately 3 log decrease was detected compared to the control group.

In another exemplary embodiment, the apple which had been washed, cut and then made ready for the solution application was kept in the solution comprising 1% chitosan and 1% ascorbic acid and left for storing in polyethylene containers at 4° C. after the process of removing the liquid remaining on thereof in this embodiment, the apple pieces cut could be maintained for 12 days at 4° C.

In another exemplary embodiment, the apples cut were kept in the solution comprising 1% chitosan and 5% ascorbic acid for preferably 10 minutes this time. After the process of removing the liquid remaining on the apples, they were left in polyethylene containers at 4° C. for storing. In this embodiment, the phenolic compound profile of the apples did not change for 2 weeks at 4° C. Also, in the control group in terms of microbiology, the total number of viable microorganisms at the end of 2 weeks was over 5.5 log₁₀ cfu/g whereas it remained at the levels of <2 log₁₀ cfu/g in the apples where 1% chitosan-5% ascorbic acid was applied. In the control group, the darkening percentage reached the level of 12 within 3 days however it was detected in the levels of 0.6% in the samples where 1% chitosan-5% ascorbic acid solution was applied. At the end of 15 days, the darkening percentage in the control group was 49 whereas the darkening was detected in the levels of approximately 8% in the samples where chitosan solution was applied.

By means of the chitosan which is included by the solution developed by the present invention, development of microorganisms is avoided on fruits and/or vegetables and thus it is enabled to keep taste of fruits and/or vegetables and it is ensured to maintain colours of fruits and/or vegetables by means of ascorbic acid. Thereby, shelf life of the said products can be extended. Due to the fact that the substances contained by the solution have no harm for health, it is ensured to consume fruits and/or vegetables without needing any cleansing process.

Within these basic concepts, it is possible to develop a. great variety of embodiments of the inventive solution and the application method thereof; it cannot be limited to the examples disclosed herein and it is essentially according to the claims.

1. A solution characterized in that it enables to extend shell life of ready-to-eat fruits and/or vegetables, restricts microbial activity on fruits and/or vegetables due to die fact that is an antimicrobial substance, enables chilosan to dissolve inside the solution by comprising preferably one per cent chitosan in the aqueous solution and increasing the acidic value of the solution, and also prevents enzymatic browning which occurs on fruits and/or vegetables due to oxidation of phenolic substances, and comprises preferably one to five per cent ascorbic acid in the aqueous solution.

2. A solution according to claim 1, characterized in that it comprises ascorbic acid in the ratio of 1% in thereof.

3. A solution according to claim 1, characterized in that it comprises ascorbic acid in the ratio of 5% in thereof.

4. A method for solution use (100) which enables to extend shelf life of ready-to-eat fresh fruits and/or vegetables; characterized by steps of:
preparing the fruits and/or vegetables where the solution will be applied, for solution application (101);
immersing the fruits and/or vegetables into the chitosan and ascorbic acid solution which is prepared in accordance with their characteristics (102) for a definite period;
after the immersing process (102) removing the liquid which remains on the fruits and/or vegetables (103); and
packaging or storing, the fruits and/or vegetables wherein the liquid remaining on thereof is removed (104);
and prepared according to claim 1.

5. A method (100) according to claim 4, characterized in that the step of preparing the fruits and/or vegetables for solution application (101) comprises steps Of washing, shelling, peeling, cutting or deseeding.

6. A method (100) according to claim 4, characterized in that the step of immersing the fruits and/or vegetables into the chitosan and ascorbic acid solution which is prepared in accordance with their characteristics (102) for a definite period is applied for 10 minutes.

7. A method (100) according to claim 4, characterized in that the step of packaging or storing the fruits and/or vegetables wherein the liquid remaining on thereof is removed (104) is carried out at 5° C.

8. A method (100) according to claim 4, characterized in that the step of packaging or storing the fruits and/or vegetables wherein the liquid remaining on thereof is removed (104) is carried out at 4° C.

9. A method according to claim 4 wherein said solution comprises ascorbic acid at a concentration of 1%.

10. A method according to claim 4 wherein said solution comprises ascorbic acid at a concentration of 5%.

11. A method (100) according to claim 5, characterized in that the step of immersing the fruits and/or vegetables into the chitosan and ascorbic acid solution which is prepared in accordance with their characteristics (102) for a definite period is applied for 10 minutes.

12. A method (100) according to claim 5 characterized in that the step of packaging or storing the fruits and/or vegetables wherein the liquid remaining on thereof is removed (104) is carried out at 5° C.

13. A method (100) according to claim 6, characterized in that the step of packaging or storing the fruits and/or vegetables wherein the liquid remaining on thereof is removed (104) is carried out at 5° C.
